(19) United States
(12) Patent Application Publication
(10) Pub. No.: US 2010/0138919 A1
(43) Pub. Date: Jun. 3, 2010

(54) SYSTEM AND PROCESS FOR DETECTING ANOMALOUS NETWORK TRAFFIC

(76) Inventors: Tao Peng, North Melbourne (AU); Christopher Andrew Leckie, Balaclava (AU); Ramamohanarao Kotagiri, South Yarra (AU)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/513,501

(22) PCT Filed: Nov. 2, 2007
(86) PCT No.: PCT/AU2007/001690

§ 371 Date: Feb. 18, 2010

Related U.S. Application Data
(60) Provisional application No. 60/856,577, filed on Nov. 3, 2006.

(51) Int. Cl. G06F 21/00; G06F 15/173

(52) U.S. Cl. 726/22; 709/224

(57) ABSTRACT

A process for detecting anomalous network traffic in a communications network, the process including: generating reference address distribution data representing a statistical distribution of source addresses of packets received over a first time period, the received packets being considered to represent normal network traffic; generating second address distribution data representing a statistical distribution of source addresses of packets received over a second time period; and determining whether the packets received over the second time period represent normal network traffic on the basis of a comparison of the second address distribution data and the reference address distribution data.

### FIELD

The present invention relates to a system and process for detecting anomalous network traffic such as that arising from a denial of service attack, and for identifying the anomalous traffic so that it can be selectively blocked.

### BACKGROUND

A denial of service (DoS) attack is a malicious attempt to cripple an online service in a communications network such as the Internet. The most common form of DoS attack is a bandwidth attack wherein a large volume of essentially useless network traffic is directed to one or more network nodes with the aim of consuming the resources of the attacked nodes and/or consuming the bandwidth of the network in which the attacked nodes reside. The effect of such an attack is that the attacked nodes appear to deny service to legitimate network traffic, and are thus effectively shut down, either partially or completely. If the attacked nodes generate income for a business, for example by providing e-commerce or other forms of commercial services to users of the network, the business itself can be effectively shut down, resulting in considerable loss of income and goodwill.

A Distributed Denial of Service (DDoS) attack is a form of DoS attack in which the attack traffic is launched from multiple distributed sources. There are two common forms of DDoS attacks, which are referred to herein as the typical DDoS attack and the distributed reflector denial of service (DRDoS) attack, and collectively as Highly Distributed Denial of Service (HDDoS) attacks. A typical DDoS attack has two stages. The first stage is to compromise vulnerable systems available in the network and install attack tools on these compromised systems. This is referred to as turning the vulnerable system computers into “zombies”. In the second stage, the attacker sends an attack command to the zombies through a secure channel to launch a bandwidth attack against the victim(s). The attack traffic is then sent from the “zombies” to the victim(s). The attack traffic can use genuine or spoofed (i.e., faked) source Internet Protocol (IP) addresses. However, there are two major motivations for the attacker to use randomly spoofed IP addresses: (i) to hide the identity of the “zombies” and hence reduce the risk of being traced back via the “zombies”; and (ii) to make it difficult or impossible to filter the attack traffic without disturbing legitimate network traffic addressed to the victim(s).

A distributed reflector denial of service (DRDoS) attack uses third-party systems (e.g., routers or web servers) to bounce the attack traffic to the victim. A DRDoS attack is effected in three stages. The first stage is the same as the first stage of the typical DDoS attack described above. However, in the second stage, instead of instructing the “zombies” to send attack traffic to the victims directly, the “zombies” are instructed to send spoofed traffic with the victim's IP address as the source IP address to the third parties. In a third stage, the third parties then send reply traffic to the victim, thus constituting a DDoS attack. This type of attack shut down www.grc.com, a security research website, in January 2002, and is considered to be a potent, increasingly prevalent and worrisome Internet attack. The DRDoS attack is more dangerous than the typical DDoS attack for the following reasons. First, the DRDoS attack traffic is further diluted by the third parties, which makes the attack traffic even more distributed. Second, the DRDoS attack has the ability to amplify the attack traffic, which makes the attack even more potent.

Sophisticated tools to gain root access to other people's computers are freely available on the Internet. These tools are easy to use, even for unskilled users. Once a computer is cracked, it is turned into a “zombie” under the control of one “master”. The master is operated by the attacker, and can instruct all its zombies to send bogus data to one particular destination. The resulting traffic can clog links, and cause routers near the victim or the victim itself to fail under the load.

At present, there are no effective means of detecting bandwidths attacks for the following reasons. Both IP and TCP can be misused as dangerous weapons quite easily. Because all Web traffic is TCP/IP based, attackers can release their malicious packets on the Internet without being conspicuous or easily traceable. It is the sheer volume of all packets that poses a threat rather than the characteristics of individual packets. A bandwidth attack solution is, therefore, more complex than a straightforward filter in a router.

One difficulty in responding to bandwidth attacks is attack detection. Detection of a bandwidth attack might be relatively easy in the vicinity of the victim, but becomes more difficult as the distance (i.e., the hop count) to the victim increases if the attack traffic is spread across multiple network links, making it more diffuse and harder to detect, since the attack traffic from each source may be small compared to the normal background traffic. Existing solutions to bandwidth attacks become less effective when the attack traffic becomes distributed. A further challenge is to detect the bandwidth attack as soon as possible without raising a false alarm, so that the victim has more time to take action against the attacker.

Previously proposed approaches rely on monitoring the volume of traffic that is received by the victim. A major drawback of these approaches is that they do not provide a way to differentiate DDoS attacks from “flash crowd” events, where many legitimate users attempt to access one particular site at the same time. Due to the inherently bursty nature of Internet traffic, any sudden increase of traffic can be mistaken for an attack. However, if the response is delayed in order to ensure that the traffic increase is not just a transient burst, this risks allowing the victim to be overwhelmed by a real attack. Moreover, some persistent increases in traffic may not be attacks, but actually “flash crowd” events. Clearly, there is a need for a better approach to detecting bandwidth attacks. There is also a need for rapidly detecting and responding to a flash crowd event. More generally, there is a need to be able to rapidly detect and respond to unusual network traffic, referred to herein as “anomalous network traffic”, examples of which include the network packets generated by events such as DoS attacks and flash crowd events.

A further difficulty in responding to DDoS attacks is that it is very difficult to distinguish between normal traffic and attack traffic. Existing rate-limiting methods punish the good traffic as well as the bad traffic.

It is desired to provide a system and process for detecting anomalous network traffic that alleviate one or more of the above difficulties, or at least provide a useful alternative.

### SUMMARY

In accordance with the present invention, there is provided a process for detecting anomalous network traffic in a communications network, the process including:
generating reference address distribution data representing a statistical distribution of source addresses of packets received over a first time period, the received packets being considered to represent normal network traffic;
generating second address distribution data representing a statistical distribution of source addresses of packets received over a second time period; and
determining whether the packets received over the second time period represent normal network traffic on the basis of a comparison of the second address distribution data and the reference address distribution data.

Preferably, the statistical distributions of source addresses are statistical distributions of aggregated source addresses.

Preferably, the source addresses have structure and are aggregated on the basis of said structure.

Preferably, each of the statistical distributions of source addresses represents numbers of received packets or proportions of the total number of received packets having source address octets with corresponding values.

Preferably, each of the statistical distributions of source addresses represents numbers or proportions of received packets having portions of source addresses with corresponding values.

Preferably, the source addresses are aggregated on the basis of geographical locations associated with said source addresses.

Preferably, said step of determining includes generating distribution distance data representing a measure of similarity of the reference address distribution data and the second address distribution data, and determining whether the packets received over the second time period represent normal network traffic on the basis of the distribution distance data.

Preferably, said step of generating distribution distance data includes generating address subset distance data representing measures of similarity of respective portions of the reference address distribution data and corresponding portions of the second address distribution data, said portions corresponding to respective subsets of source addresses, said distribution distance data being generated from the address subset distance data.

Preferably, the step of generating the distribution distance data from the address subset distance data includes generating a weighted linear combination of the respective measures of similarity.

Preferably, said step of generating distance data includes determining a Mahalanobis distance between the two distributions.

Preferably, said step of determining includes processing respective distribution distance data generated for successive second time periods to generate filtered distribution distance data, said step of determining whether the packets received over the second time period represent normal network traffic being based on the filtered distribution distance data to improve the reliability of said determining.

Preferably, said step of processing includes generating a cumulative sum of the distribution distance data generated for successive second time periods.

Preferably, each of said reference address distribution data and said second address distribution data includes count data representing numbers of received packets having source addresses falling within respective source address subsets, and proportion data representing proportions of received packets having source addresses falling within said respective source address subsets.

Preferably, the process includes processing the reference address distribution data and the second address distribution data to generate updated reference address distribution data representing a statistical distribution of network addresses of packets received over an updated time period determined by extending the first time period to include the second time period, providing that said step of determining determines that the packets received over the second time period represent normal network traffic; wherein subsequently the updated reference address distribution data is used as the reference address distribution data and the updated time period is used as the first time period.

Preferably, the updated reference address distribution data is generated as a weighted linear combination of the reference address distribution data and the second address distribution data.

Preferably, the process includes selecting, in response to determining that the packets received over the second time period do not represent normal network traffic, at least one subset of the source addresses of packets received over the second time period, the subset of source addresses being selected on the basis of the comparison of the second address distribution data and the reference address distribution data.

Preferably, the process includes generating goodness values for respective selected source addresses, each of the goodness values representing a likelihood of packets having the corresponding source address representing abnormal network traffic.

Preferably, said goodness values are generated based on prior visiting behaviour associated with the selected source addresses.

Preferably, the process includes determining whether to block, rate-limit, or further process packets having each selected source address on the basis of said goodness values.

Preferably, the step of determining whether the packets received over the second time period represent normal network traffic includes determining whether the packets received over the second time period may represent a denial of service attack.

The present invention also provides a computer-readable storage medium having stored thereon program instructions for executing the steps of any one of the above processes.

The present invention also provides a system having components for executing the steps of any one of the above processes.

The present invention also provides a system for detecting anomalous network traffic in a communications network, the system including:
a source address distribution generator for generating:
   reference address distribution data representing a statistical distribution of source addresses of packets received over a first time period, the received packets being considered to represent normal network traffic; and
   second address distribution data representing a statistical distribution of source addresses of packets received over a second time period;
and
a network traffic assessment component for determining whether the packets received over the second time period represent normal network traffic on the basis of a comparison of the second address distribution data and the reference address distribution data.

Preferably, the source address distribution generator maintains address distribution data structures representing statistical distributions of source addresses of received packets, the address distribution data structures including a packet count data structure storing counts of received packets having source addresses falling within respective subsets of source addresses, and a packet proportion data structure storing proportions of the total number of received packets having source addresses falling within respective subsets of source addresses.

Preferably, the subsets of source addresses correspond to respective octets of said source addresses.

### BRIEF DESCRIPTION OF THE DRAWINGS

Preferred embodiments of the present invention are hereinafter described, by way of example only, with reference to the accompanying drawings, wherein:

FIG. 1 is schematic diagram of a preferred embodiment of a packet filtering system interposed between a secure communications network and an insecure communications network such as the Internet;

FIG. 2 is a block diagram of a denial of service (DoS) attack detector of the packet filtering system of FIG. 1;

FIG. 3 is a block diagram of a statistical distance analyser of the DoS attack detector;

FIG. 4 is a flow diagram of a statistical distance process of the statistical distance analyser;

FIG. 5 is a schematic diagram of a data structure used to store source address distribution data representing a statistical distribution of source addresses of packets received by the system;

FIG. 6 is a schematic diagram illustrating how the statistical distance process uses the data structure of FIG. 5 to detect abnormal network traffic conditions such as a DoS attack;

FIG. 7 is a schematic diagram illustrating the weighting applied to distance values determined with respect to reference address distribution data for contiguous reference time periods;

FIG. 8 is a schematic diagram illustrating the sliding window used to generate goodness values for selected source addresses;

FIG. 9 is a schematic diagram illustrating the determination of binary-valued goodness values for various possible scenarios of visiting behaviour and their relationships with the sliding window and three visiting behaviour parameters a, b, and c; and

FIG. 10 is a schematic diagram illustrating the generation of three parameters a, b, and c representing the visiting behaviours associated with a source address.

### DETAILED DESCRIPTION OF THE PREFERRED EMBODIMENTS

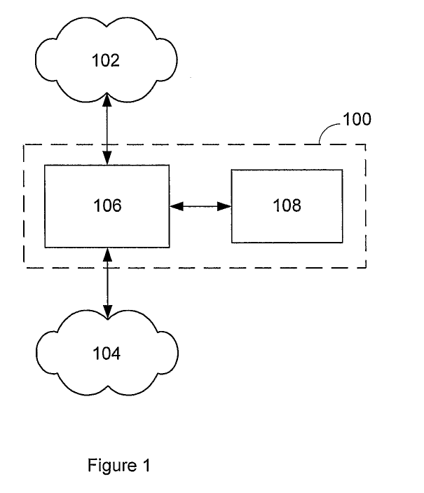

As shown in FIG. 1, a packet filtering system 100 executes a packet filtering process that receives data packets originating from an insecure communications network 102 such as the Internet, monitors the packets for unusual or anomalous network traffic, in particular those caused by security attacks, and determines which packets to forward to a secure network 104 and which packets to drop or rate-limit in order to protect the secure network 104. The packet filtering system and process are described below in terms of detecting denial of service (DoS) attacks. However, it will be apparent from the description below that the packet filtering system and process can detect anomalous network traffic arising from other causes, including flash crowd events.

The packet filtering system 100 includes a packet filter 106 and a denial of service (DoS) attack detector 108 that analyses packets received from the insecure network 102 in order to detect denial of service attacks on the secure network 104 (i.e., on one or more network nodes, servers or other types of network-accessible systems, devices, or other components of the secure network 104) and to generate filter data identifying packets associated with a detected DoS attack. The packet filter 106 uses the filter data to drop or rate-limit packets associated with the DoS attack.

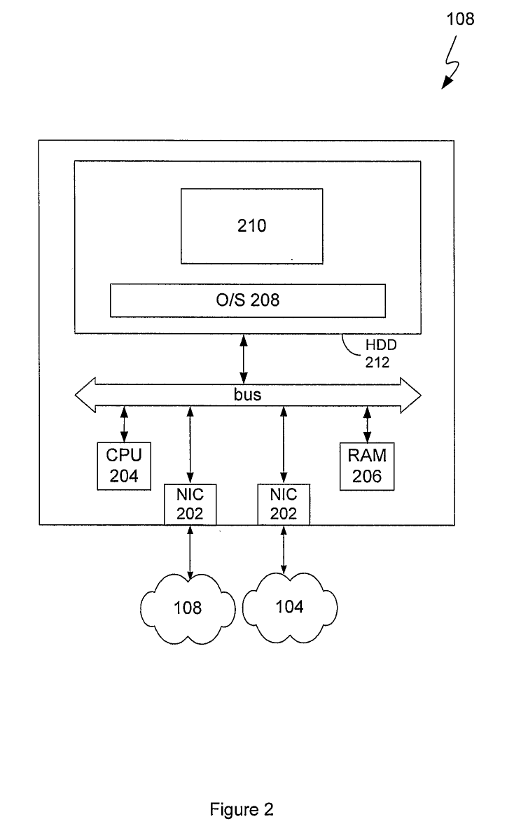

As shown in FIG. 2, the DoS attack detector 108 includes two or more network interface connectors (NICs) 202 connected to the insecure network 102 and the secure network 104, at least one processor 204, random access memory (RAM) 206, an operating system 208, and a statistical distance analyser 210.

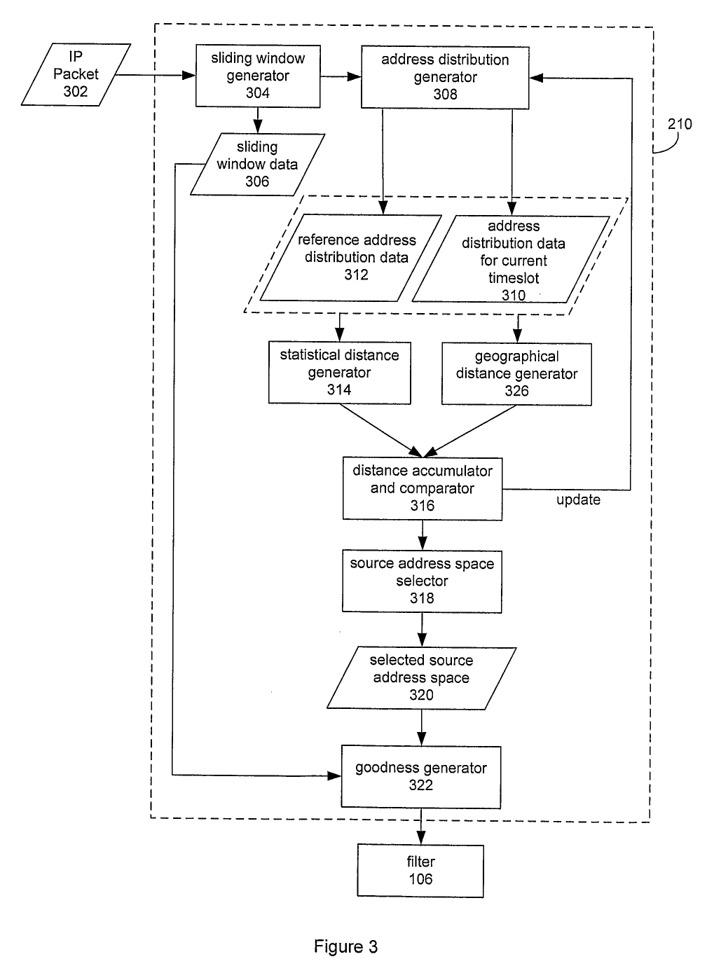

In the described embodiment, the DoS attack detector 108 is a standard computer system, such an Intel Architecture based server executing a standard operating system such as Linux™ (preferably carrier-grade, as described at http://www.osdl.org), and the statistical distance analyser 210 is implemented in the form of programming instructions of one or more software modules, as shown in FIG. 3, stored on non-volatile (e.g., hard disk) storage 212 associated with the computer system, as shown in FIG. 2. However, it will be apparent that at least parts of the statistical distance analyser 210 could alternatively be implemented as one or more dedicated hardware components, such as application-specific integrated circuits (ASICs) and/or field programmable gate arrays (FPGAs).

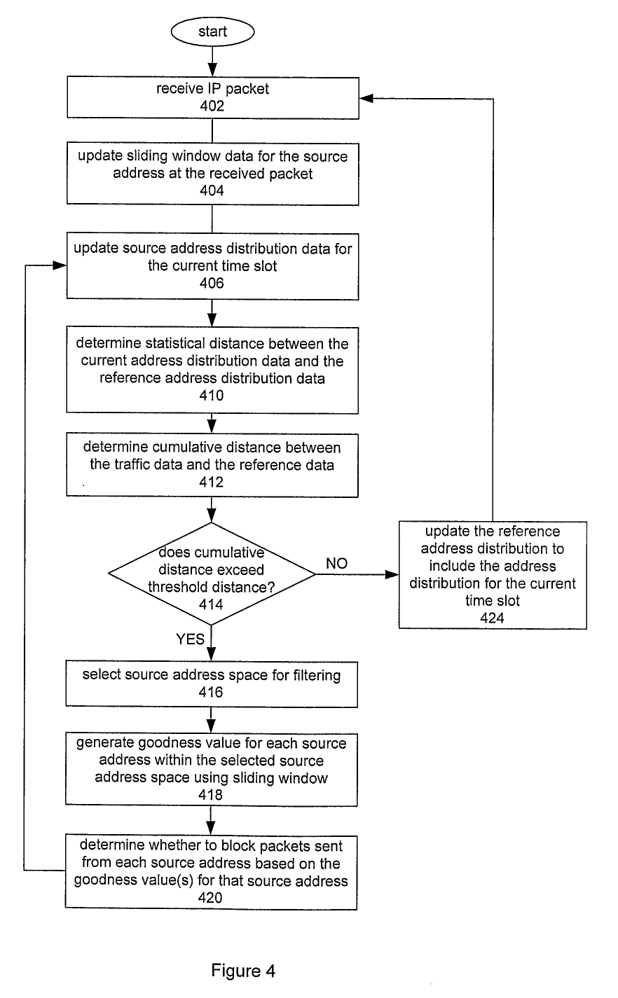

The statistical distance analyser 210 provides a statistical distance process, as shown in FIG. 4, that processes network packets received from the insecure network 102 to assess whether those packets may represent a denial of service attack on the secure network 104, based on statistical properties of the source addresses of those packets.

As described in T. Peng, C. Leckie, and K. Ramamohanarao, “Prevention from distributed denial of service attacks using history-based EP filtering,” in Proceeding of 38th IEEE International Conference on Communications (ICC 2003), Anchorage, Ak., USA, August 2003, pp. 482-486, empirical studies of Internet traffic have demonstrated that, for a given network destination, the source IP address space is relatively stable. Moreover, the volume of network traffic originating from various subsets of the IP address space has also been found to be relatively stable. This statistical stability indicates that the geographical distribution of source IP addresses is similarly stable. For example, due to geographical considerations, the University of Melbourne network receives most network traffic from IP addresses within Australia, and a relatively minor proportion of scattered traffic from other IP address spaces, such as those assigned to eastern European countries.

This statistical stability can be used to detect anomalous network traffic such as that arising from a DoS attack. For example, a sudden increase in the proportion of network traffic originating from eastern European countries could be indicative of a DoS attack on a University of Melbourne network. However, the amounts of network traffic sent to a particular destination from individual source IP addresses within one IP address space can differ due to human factors. For example, a University of Melbourne student at a private residence (whose IP address is determined by their ISP) is expected to visit the University of Melbourne's website more frequently than a bank employee.

A malicious attacker causing a denial of service attack on a particular network server or network has no way of knowing the entire source IP address space from which IP packets are sent to the intended victim server or network, nor of the relative proportions of traffic sent from each source IP address or subset of source IP addresses. However, the launching of a denial of service attack on the network will inevitably change the statistical distribution of source addresses of network traffic directed to the target network, and this change allows the attack to be detected and an appropriate response made.

Accordingly, the statistical distance analyser 210 maintains address distribution data representing a statistical distribution of source IP addresses of IP packets addressed to the secure network 104. Alternatively, the address space of the secure network 104 can be divided into subsets of IP addresses (one or more of which can be specific IP addresses of targeted servers if desired), and statistical distributions for each subset maintained independently. In any case, by generating the address distribution data for packets received over a time period up to the current time, and comparing this data to reference address distribution data representing normal network traffic (i.e., in the actual or apparent absence of any DoS attack), preferably for substantially the same time of day, any significant deviations of the current statistical distribution of source address from the reference or ‘normal’ statistical distribution can be used (i) to assess whether it appears likely that a denial of service attack is being made on the secure network 104, and (ii) to select a subset of the entire IP address space giving rise to this difference, thus allowing packets with source addresses within this address space to be blocked completely, blocked partially (e.g., rate-limited), and/or processed further to provide a more thorough assessment of whether an attack is indeed occurring, to further analyse properties of suspicious or attack packets, and/or to identify particular source IP addresses of the offending packets.

In IP version 4, IP addresses are 32 bits long, and consequently there are 2³² different IP addresses defining the entire IP address space. Clearly, it is impractical to store statistical data representing each possible source address. Moreover, even though a given network would clearly not receive traffic from the entire possible IP address space, it may also be impractical from a storage and computational point of view to store each source address of packets actually received by that network. For example, a detailed study of the source IP addresses of packets received at the University of Melbourne Computer Science and Software Engineering Department over a period of one week identified 2 million unique source addresses. To reduce storage and computational resource requirements, the statistical distance analyser 210 uses a relatively compact data structure that exploits the internal structure of the IP address space to effectively store a statistical representation of the source IP addresses of packets received by a network. As will be appreciated by the skilled addressee, 32-bit IP v4 addresses are structured as four 8-bit binary numbers or bytes, often referred to as octets. Consequently, IP addresses are usually represented as a set of four octets separated by full stop or period characters, in the general form A.B.C.D. Moreover, the IP address space is usually partitioned into networks by IP prefixes, and these networks are assigned to organisations. Each byte or octet of an IP address therefore represents a different level of information.

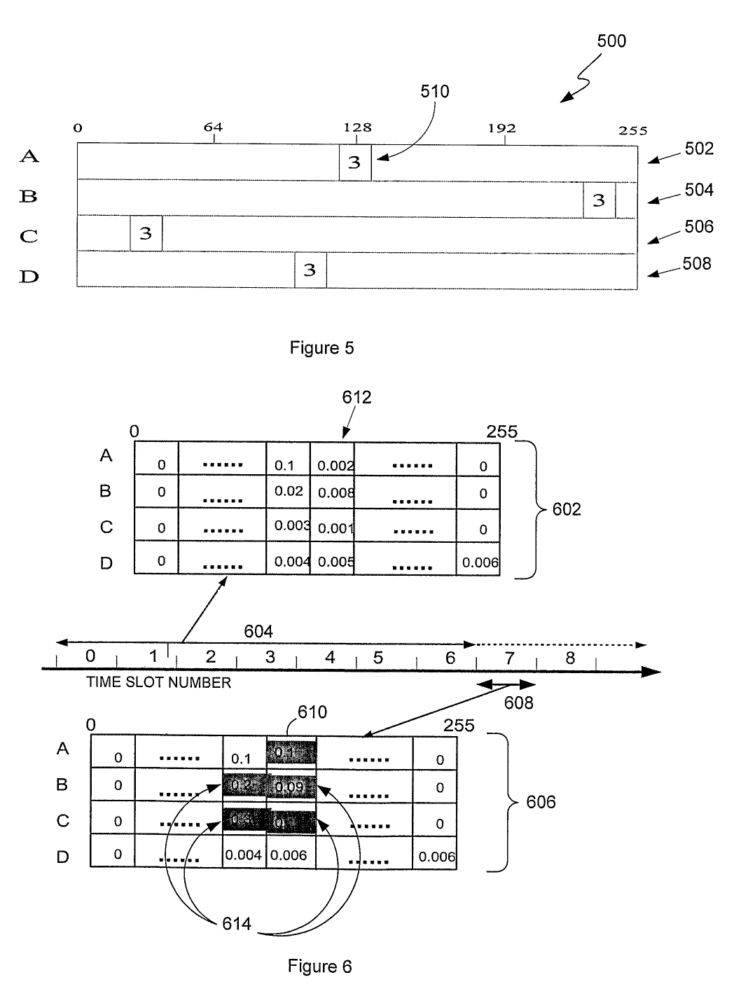

FIG. 5 is a schematic representation of the data structure 500 used by the statistical distance analyser 210. The data structure 500 is divided into four portions 502, 504, 506, 508, shown schematically as rows, corresponding to the four bytes or octets of each IP address. Each byte of an IP address has a value from 0 to 255, and each row of the data structure provides 256 individual counters that can be updated to represent the statistical distribution of values of the corresponding bytes of the source IP addresses of packets received. For the purposes of illustration, FIG. 5 shows how the data structure 500 can be used to represent the receipt of three packets from the source IP address 128.250.34.115. Thus, for example, the counter 510 maintains a count of the number of source IP addresses whose first byte has the value of 128. This data structure 500 is thus able to represent, albeit in partially aggregated form, the traffic distribution of the entire IP v4 address space using only 4×256=1024=2¹⁰ counters instead of 2³² counters. The four portions 502 to 508 of the data structure 500 thus represent four levels of the statistical distribution of network traffic, represented herein as qₖ(A), qₖ(B), qₖ(C) and qₖ(D), each of which is an array or vector of 256 values. For practical reasons that will become apparent from the following description, two versions of the counters are maintained. In one version, the 1024 counters store absolute packet counts, as described above. In the other version, each of the 1024 counters is not actually used to store the number of received packets having a corresponding source address value, but rather the fraction of received packets having that source address value. This latter version is the one that is predominantly used to detect DoS attacks, with the absolute count version being used to prevent false alarms, as described below. Unless stated otherwise, it should be assumed that the counters storing the floating point or real valued fractions or proportions of received packets are used.

The statistical distance process is described in detail below, but can be briefly summarised as follows. The data structure of FIG. 5 is populated during a period in which the network being protected, in this case the secure network 104, is not subject to a denial of service attack, flash crowd, or any other unusual network traffic, as assessed, for example, by a network administrator of the secure network 104. The resulting address distribution data, which is preferably separately prepared for different periods of each day (e.g., each hour), and possibly also for each day of the week, each month, etc., therefore constitutes normal or reference address distribution data against which dynamically generated address distribution data for the current assessment period (referred to herein as the ‘current time slot’) can be compared to determine whether the current distribution of source IP addresses is significantly different from the distribution of source addresses of packets received under normal conditions. A significant deviation may indicate that a DoS attack is underway. The statistical distance process generates distance data representing a numeric value, referred to as statistical distance, that quantifies the difference between the two distributions in a statistical meaningful manner. If the statistical difference exceeds a threshold distance value, then the network packets received during the current time slot are not considered to represent normal network traffic, indicating that a DoS attack or flash crowd event may be underway. In either case, the change in the distribution of network traffic poses a risk to the secure network 104 and is responded to in order to protect the secure network 104 from excessive network traffic while allowing returning visitors to access the secure network 104, as described below.

In order to prevent false alarms, the absolute packet counters are also used. For example, if for some reason the secure network 104 suddenly becomes unreachable from all but a small subset of source addresses (perhaps those topologically close to the secure network, for example), the process described above will indicate that the proportion of traffic received from that small subset had suddenly increased. Yet the actual number of packets received from that subset may be substantially unchanged, or may even have decreased. Hence the counters storing absolute numbers of received packets are used to prevent such events from being incorrectly attributed to a DoS attack.

For example, as shown in FIG. 6, reference address distribution data 602 can represent a statistical distribution of source IP addresses of packets received on an earlier day (e.g., the same day of the previous week), or alternatively, as illustrated, can be continuously updated in real-time to represent the actual statistical distribution of source IP addresses of packets received in a time period up to the current time, but excluding the current time slot being assessed for DoS attacks, as shown schematically in FIG. 8, and described further below. As shown in FIG. 6, in this case the continually updated reference address distribution data 602 is generated from a sliding time window 604 of predetermined length that lags behind the current time by the length of the current time slot 608 being analysed.

For the purposes of explanation, FIG. 6 shows the reference distribution data 602 being generated from a window 604 consisting of time slots 0 to 6, with the address distribution data 606 being generated for a current time slot (number 7) 608. By comparing the current address distribution data 606 to the reference address distribution data 602, an assessment can be made of whether the statistical distribution of source IP addresses of packets received in the current time slot 608 differs significantly from the distribution of source IP addresses of packets received during the reference or training period 604. Moreover, by comparing individual counters of the current data structure 606 with the corresponding counters of the reference data structure 602, it is also possible to identify a source IP address space giving rise to this difference. Packets having source IP addresses within this address space can be blocked, rate-limited, or otherwise filtered or subjected to further processing, as desired. For example, in FIG. 6, a counter 610 representing the portion of source IP addresses having a corresponding value in their first byte is 50 times greater than the value of the corresponding counter 612 in the reference structure 602. By identifying this counter 610, and other counters 614 showing similar deviations from the corresponding reference values, it is possible to identify a source IP address space associated with the sudden increase in the proportion of network traffic. As described above, corresponding counters storing absolute numbers of received packets (rather than proportions of received packets) are used to prevent false alarms. It may be observed that the source address aggregation resulting from the above methodology decouples the four IP address octets so that the source IP address space determined as described above is not guaranteed to always correctly represent the actual attack address space. However, it will also be appreciated that in practice the likelihood that the address space thus determined does not represent the actual attack address space is extremely low.

If the two distributions 602, 606 are sufficiently similar, then the address distribution data for the current time slot 606 can be combined with the reference address distribution data 602 to provide continuous learning, and continuously update the reference address distribution data 602 as time progresses.

As shown in FIGS. 3 and 4, the statistical distance process begins at step 402 when the statistic distance analyser 210 receives an IP packet 302 from the insecure network 102. At step 404, a sliding window generator 304 determines the source address of the IP packet 302, and uses this to update sliding window data 306 for the determined source address, as described further below. At step 406, an address distribution generator 308 generates or updates source address distribution data for the current time slot.

As described above, the statistical distance process uses data structures of the form 500 shown in FIG. 5 to represent the distribution of source IP addresses of received packets. For performance reasons, the statistical distance generator 210 uses two data structures of the general form 500 to represent the distribution of source addresses. First, a count distribution data structure consisting of 1024 integer counters arranged as shown in FIG. 5 is used to accumulate raw counts of the number of source address octets having corresponding values. The raw counts are accumulated over one time slot period, being a relatively short measurement interval that can be configured by a system administrator, but is typically about one second. A separate counter maintains a count of the total number of packets of all source addresses received during this time period. At the end of each measurement interval, the raw counts are used to generate the address distribution data for the current time slot by dividing each raw count value by the total number of counts received over the measurement interval to provide 1024 floating point values representing the fractions of all packets received over the corresponding time periods having source address octets with corresponding values. These fractional values for the current time slot are compared to the corresponding values of reference address distribution data 312, as described below, and the comparison determines whether a DoS attack may be underway. If no attack is detected, the address distribution data for the current time slot is used to update the reference address distribution data 312, as described below. A third data structure of the same form 500 is used to store raw counts of the number of source address octets having corresponding values for the same measurement interval. As described above, this data structure is used to prevent false alarms.

Alternatively or additionally, each source IP address can be mapped to a geographical location (e.g., a country code) in order to provide a different form of source address aggregation, with a significant change in the statistical distribution of different geographical locations from which received packets have proportionately originated potentially indicating a DoS attack. When this form of address aggregation is used, the statistical distance between the two distributions is referred to herein for convenience as a ‘geographical distance’, notwithstanding that it remains a measure of the difference between two statistical distributions. In this case the (geographical) distributions are not stored in structures of the form 500 described above, since the aggregation no longer corresponds to the IP address structure but rather to the available geographical country codes. It will be apparent to those skilled in the art that other mappings from IP source addresses to categories could be used, alternatively or additionally. For example, WHOIS queries could be used to map IP addresses to organisations or other entities, with a significant change in the statistical distributions of such categories being indicative of a possible DoS attack.

The statistical distance process can quantify the similarity/difference between the address distribution data for the current time slot 310 and the reference address distribution data 312 in a number of different ways. Statistical methods are used to compare the two discrete distributions and thereby determine a single numerical value that quantifies the statistical difference or statistical ‘distance’ between the two distributions.

Returning to FIG. 4, at step 410 the statistical distance generator 314 generates a numerical distance measure representing the statistical difference between the current address distribution data and the reference address distribution data using one of two available statistical methods. The first method is known as the relative entropy or Kullback-Leibler distance. Given two discrete distributions pᵢ and qᵢ, where i=1, 2, 3, . . . , m, the Kullback-Leibler distance from pᵢ to qᵢ is defined by:

$$d = {\sum }_{k = 1}^{m} {p}_{k} {log}_{2} \frac{{p}_{k}}{{q}_{k}} \qquad ( 1 )$$

where pᵢ and qᵢ respectively represent the current and reference distributions of traffic sent from IP address space i, where i is a subset of the total source IP address space 1,2, . . . , m. It will be observed that the Kullback-Leibler distance is not symmetric.

Alternatively and preferably, the second statistical method determines what is known as the Mahalanobis distance between the two statistical distributions, as:

d²(x, y̅)=(x− y̅)^{T}C⁻¹(x− y̅) (2)

where x and y̅ are two feature vectors, and each element of each vector is a variable. x is the feature vector of the new observation (in this case the fractions of packets having various source address octets in a particular measurement interval), and y̅ is the averaged feature vector from the training examples (i.e., the reference distribution), each of which is a vector. C⁻¹ is the inverse covariance matrix as Cᵢⱼ=Cov(yᵢyⱼ). yᵢ and yⱼ are the ith and jth elements of the training vector.

The Mahalanobis distance has the advantage of factoring in each measured variable's variance, covariance and average value. The four levels of IP address space are treated separately, meaning the entire IP address space is represented by four feature vectors each containing 256 elements. For example, each element of the vectors in FIG. 6 represents the proportion of traffic from one particular IP address space (e.g., traffic from *.250.*.*.) On the naive assumption that elements within each vector are independent, the covariance matrix C becomes diagonal and the elements along the diagonal are the variances of the proportion of traffic having source addresses in each IP address space.

Using a simplified Mahalanobis distance avoids time-consuming square and square-root computations:

$$d ( x , \overline{y} ) = {\sum }_{i = 0}^{n - 1} ( \vert {x}_{i} - {\overline{y}}_{i} \vert / {\overline{σ}}_{i} ) \qquad ( 3 )$$

where σ̅ᵢ is the standard deviation of the current distribution data 310. However, for the simplified Mahalanobis distance the standard deviation σ̅ᵢ is likely to be 0, which makes the distance infinite. This occurs when there is no traffic or traffic variation from one particular IP address space. To avoid this situation, a smoothing factor (α) is added to the standard deviation, as follows:

$$d ( x , \overline{y} ) = {\sum }_{i = 0}^{n - 1} ( \vert {x}_{i} - {\overline{y}}_{i} \vert / ( {\overline{σ}}_{i} + α ) ) \qquad ( 4 )$$

The smoothing factor α represents the statistical confidence of the sampled training data. The larger the α value, the lower the confidence that the samples accurately represent the actual distribution.

In the described embodiment, the statistical distance generator 314 generates the simplified Mahalanobis distance of Equation (4) for each of the four feature vectors A, B, C, and D (corresponding to the four levels of IP address space as shown in FIGS. 5 and 6), and then generates a numerical distance measure as a linear combination of these four distance values, as follows:

d=w(A)*d(A)+w(B)*d(B)+w(C)*d(C)+w(D)d(D),

where the weighting parameters w(A), w(B), w(C), and w(D) satisfy w(A)>w(B)>w(C)>w(D), and are set by an administrator. The default values for these factors are w(A)=0.6, w(B)=0.2, w(C)=0.15, and w(D)=0.05.

Having generated, at step 410, a numerical distance measure representing the distance between the two address distributions 310, 312, at step 412 a distance accumulator and comparator 316 generates a cumulative distance measure from the newly determined distance measure and previously determined distance measures for the immediately preceding time slots. The distance measure itself is not used in isolation to determine whether a DoS attack may be occurring, because Internet traffic is inherently dynamic, with significant variations occurring under normal conditions, i.e., in the absence of a DoS attack. Accordingly, the cumulative distance is used to effectively smooth or filter out background noise (i.e., traffic variation) using a Cumulative Sum (CUSUM) method, as described in B. E. Brodsky and B. S. Darkhovsky, Nonparametric Methods in Change-point Problems, Kluwer Academic Publishers, 1993. The cumulative distance is determined as the cumulative sum of the distance values determined for each time slot (measurement) interval or with the constraint that if the sum becomes negative in any time slot it is reset to zero at that time. It will be apparent that other methods could alternatively be used to filter out background noise.

Having determined a cumulative distance value at step 412, a test is performed at step 414 to determine whether this cumulative distance exceeds a user-configurable threshold distance value. If the cumulative distance does exceed the threshold, then at step 416 a source address space selector 318 processes the current and reference address distribution data 310, 312 to select a source address space for filtering or other processing. This is achieved by comparing each individual counter of the current address distribution data 310 with the corresponding counter of the reference address distribution data 312. An octet i of the source IP address space is selected if:

(|xᵢ− y̅ᵢ|/( σ̅ᵢ+α))>Threshold,

where the adjustable Threshold value has a default value of 10. The selected octet values are then combined to define a selected source address space. If no octet value is selected for any given octet, then all values of that octet are selected.

Once the source address space selector 318 has selected, at step 416, a source address space 320 from which an unusually high proportion of packets has been received, at step 418 a goodness generator 322 is used to generate a goodness value for each received packet having a source IP address with the selected address space of the selected source addresses. The goodness value is a numeric value that is considered to represent the likelihood that packets having that source address are benign, i.e., are not associated with a DoS attack. The goodness value associated with an IP address can therefore be used to decide whether to block, rate limit, or otherwise filter or further process packets with that source address.

The goodness generator 322 generates a goodness value for each source IP address from sliding window data 306 based on the temporal characteristics (e.g., frequency and duration) of revisits to the secure network 104 from that source IP address. The term ‘visit’ is intended to represent separate sessions or uses of applications that transmit packets to the secure network 104, rather than the receipt of individual packets. For example, in the context of an HTTP request, a user of a web browser accessing a web server within the secure network 104 will typically access that web server at different times separated by a relatively large time period, with each visit or session involving the generating and sending of many packets to the web server, separated by a much smaller period of time. A brute force method of evaluating the temporal characteristics of visits to a web server within the secure network 104 would be to keep timestamps of the receipt of IP packets having that source address. However, this would require a substantial amount of data storage and processing. To reduce these resources, the goodness generator 322 uses an efficient ‘sliding window’ methodology to represent the visiting behaviour associated with each source IP address, where the sliding window is defined by two configurable parameters, window_start and window_end. The methodology is based on associating only three timestamps with each source IP address, respectively referred to herein by the symbols a, b, and c. (The two configurable parameters and the three timestamps for each source address constitute the sliding window data 306 referred to above.) For each source LP address, these three values are determined as shown in the following pseudocode:

a = b = c = 0
window_size = window_end − window_start
do {

receive_packet( );
if current_time − c > window_size then

# previous packet was received
# more than window_size ago
a = c
b = c = current_time

else

c = current_time

end if

}

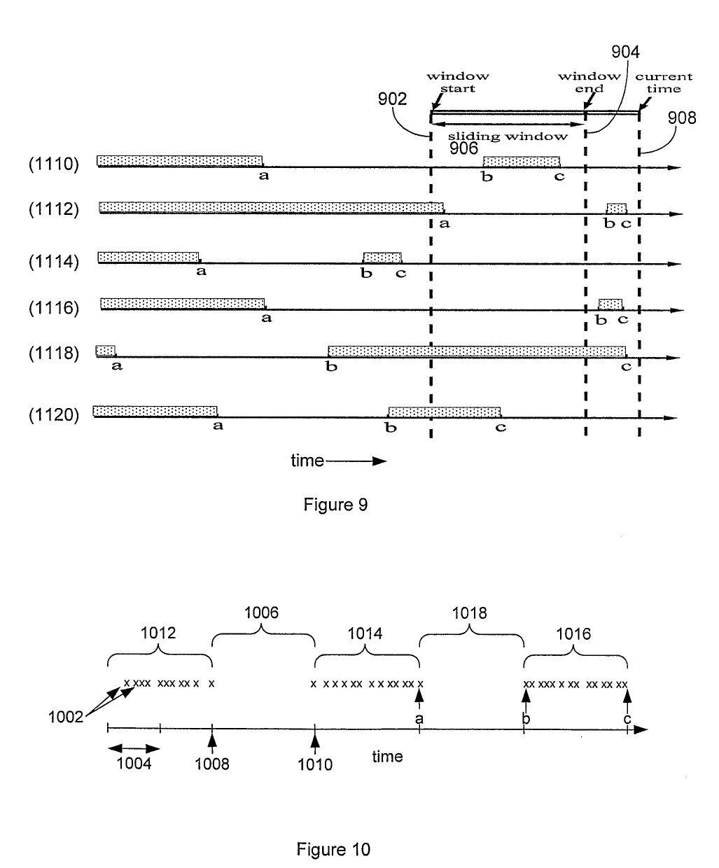

As shown in FIG. 9, the parameters window_start (represented by dashed line 902) and window_end (represented by a dashed vertical line 904) define a sliding window 906 of fixed size in the time dimension, and which lags behind the current time (represented by the vertical dashed line 908) by a fixed but configurable amount. It is assumed that the sliding window period (window_size=window_end−window_start) is always larger than the lag period (current_time−window_end).

Referring to the above pseudo-code, it can be seen that variable c is set to the time at which the previous packet having the same source address was most recently received. Consequently, the first test determines whether the time period between receipt of the current packet and receipt of the previous packet was more than window_size time ago. If the gap in time between these packets is less than or equal to window_size, then only the variable c is updated to the current time. Otherwise, the variable a is set to the time of receipt of the previous packet, and variables b and c are both set to the current time. Therefore, variable c always represents the time of receipt of the most recent packet, and variable b represents the time of receipt of the first of a series of one or more packets received after a gap in time greater than window_size.

The meaning of these three variables can be explained with reference to FIG. 10, which illustrates the receipt of packets having a particular source address over a period of time, where each “x” symbol represents receipt of a single packet. The period of time defined by window_size is represented by the double headed arrow 1004. Considering the “x” symbols 1002 starting from left and moving right (i.e., forward in time), it can be seen that the first eleven x packets 1002 are spaced apart by varying periods of time, all of which are less than window_size 1004. Consequently, on receipt of each of these packets, only variable c, representing receipt time of the most recent packet, is updated. However, the gap in time 1006 between the time of receipt 1008 of the eleventh packet, and the time of receipt 1010 of the twelfth packet, is greater than window_size 1004. Constantly, variable a is set to the time of receipt of the previous (i.e., the eighth) packet 1008, and variables b and c are both set to the time of receipt 1010 of the current (twelfth) packet. As each of the next eight packets are received, the time period between receipt of each of these packets and the previous packet is less than window_size 1004, and constantly only variable c is updated. It will be apparent that the overall result of this process is the separation of received packets into groups 1012, 1014, 1016 of packets separated by gaps 1006, 1018, where the time periods between each packet within a group is less than or equal to window_size, and each of the groups 1012 to 1016 is separated by a time period greater than window_size. The meaning of the variables a, b, and c, is thus apparent as illustrated in FIG. 10: variable a represents the time of receipt of the last packet of the previous group 1014, variable b represents the time of receipt of the first packet of the last group 1016, and variable a represents the time of receipt of the last packet of this group 1016. These groups 1012 to 1016 are considered to represent “visits”, which appropriately describes the case where the packets 1002 contain HTTP requests initiated by a user of a web browser “visiting” a particular website hosted within the secure network 104.

The three values, a, b, and c, generated for each source IP address are used by the goodness generator 322 to evaluate the likelihood that packets with that particular source IP address represent part of a DoS attack. This can be done in at least two ways. Most simply, the three variables can be used to make a binary decision as to whether the packets are good or bad, according to the following pseudocode:

if (((c > window_start) && (b < window_end)) ||

(a > window_start)) then

return true

else

return false

end if

To illustrate the generation of a goodness value for a source IP address, the sliding window parameters may be as illustrated in FIG. 9. A typical value for window_size is 7 days, and window_end 904 is typically 3 hours earlier than the current time 908. FIG. 9 shows a variety of different possible scenarios of visits relative to the sliding window 906. Where the time periods between values b and c have been shaded to represent the receipt of a stream of packets. It will be apparent that the first part of the conditional test in the above pseudocode will be true if any part of the most recent visit falls within the sliding window period 906. Similarly, the final conditional test will be true if the end of the penultimate visit falls within the sliding window 906. Accordingly, the pseudocode will return a true value if either or both of the final and penultimate visits fall within the sliding window 906. Consequently, it will be immediately apparent that, of the six scenarios 1010 to 1020 shown in FIG. 9, only the third scenario 1014 and fourth scenario 1016 do not meet the binary goodness criterion, and thus the pseudocode will return a false value, while the other four scenarios 1010, 1012, 1018, and 1020 will all return a true value, and are thus deemed to represent the receipt of good packets that are not part of a DoS attack. The meaning that thus can be assigned to these criteria is that, whether there has been a sudden increase in the relative proportion of packets having the particular source address, if packets from that address have also been received within the past week or so, then they are thus considered to represent genuine network traffic, and not DoS attack packets.

Although this method of generating a binary-valued goodness value is useful, in alternative embodiments or applications of the DoS attack detector 108 it may be preferable to generate a goodness value with finer granularity. Accordingly, the goodness generator 322 can be configured to generate a continuous floating point value for goodness, as follows:

smoothing_factor = Total_System_Running_Time/100
$goodness\_offset = \frac{( c - b ) * count\_a}{smoothing\_factor / 100 + ( c - b ) * count\_a}$
if ( ((c > window_start) && (b < window_end)) ∥

(a > window_start) ) then

return goodness_offset

else

return -1.0 + goodness_offset

end if

These steps meet two criteria. The first is that high goodness values are assigned to source addresses that frequent the secure network 104 often, with short intervals between visits. The value (c−b) quantifies this criterion. A large (c−b) value indicates that the IP address visited the secure network 104 a long time ago (e.g., at least a week ago), and that the gap between each visit is generally smaller than the sliding window size (typically about one week).

The second criterion is that high goodness values are assigned to source addresses that frequent the secure network 104 many times with long intervals between visits. This is achieved by maintaining for each source address a counter count_a that records the number of times the parameter a has been changed. A large count_a value indicates that the source address visited the secure network 104 often. The parameter total_system_running_time represents the elapsed time since the statistical distance system 310 began operating. The values generated by the above process provides values close to 1.0 for IP addresses active in the sliding window with large ((c−b)*count_a) values, and produces values close to 21.0 for source IP addresses inactive in the sliding window and with small ((c−b)*count_a) values.

The goodness values generated by this process are robust against infiltrating attacks from botnets, and the process produces continuous goodness values with high granularity that can be used by other processes to make more accurate filtering decisions. DoS attacks launched against the secure network 104 via botnets can be detected almost instantaneously. The bots would have to have visited the secure network 104 for a long time (e.g., up to one year) prior to the attack in order to achieve sufficiently high goodness values to elude detection. Botnets can easily mimic legitimate packet content and packet arrival time, but can not easily mimic long-term loyal customers.

Having generated goodness values for respective source addresses, at step 420 these values are used to determine whether to block or otherwise filter or process packets having those source addresses.

Returning to FIG. 4, if, at step 414, it is determined that the cumulative distance value does not exceed the threshold distance value, then optionally at step 424, the address distribution data 310 for the current time slot can be used to update the reference address distribution data 312 to improve the accuracy of the latter. Specifically, the reference address distribution data 312 is updated using an incremental learning model referred to as the exponentially weighted moving average (EWMA), as follows. The data structure 500 of FIG. 5 that is used to store both the reference and the current address distribution data 310, 312 can be represented by a 4×256 matrix. For each element T[i][j] in the 4×256 matrix, where i=0, 1, . . . , 3 and j=0, 1, 2, . . . , 255, the element represents the proportion of total traffic from its source address space. In particular, the following equation stands:

$${\sum }_{j = 0}^{j = 255} T [ 0 ] [ j ] = {\sum }_{j = 0}^{j = 255} T [ 1 ] [ j ] = {\sum }_{j = 0}^{j = 255} T [ 2 ] [ j ] = {\sum }_{j = 0}^{j = 255} T [ 3 ] [ j ] = 1. \qquad ( 5 )$$

Let T_{Normal}[i][j] represent the normal or reference traffic distribution, and T_{current}[i][j] represent the current slot traffic distribution. The normal traffic distribution is updated as follows:

T_{NormalNew}[i][j]=(1−K)·T_{Normal}[i][j]+K·T_{New}[i][j], (6)

where K is the EWMA weighting factor (0<K<1), as configured by a system administrator (but typically set to 0.2).

Alternatively, if the system is not configured to continually update the reference address distribution data 312, then the latter is determined from stored IP address traffic from one or more previous days. In this situation, the reference address distribution data 312 is stored as a plurality of data structures 500, each representing statistical address distribution data for a particular part (preferably hour) of the day, and the address distribution data for the current time slot 310 is compared against one or more of these populated data structures, depending on the time of day.

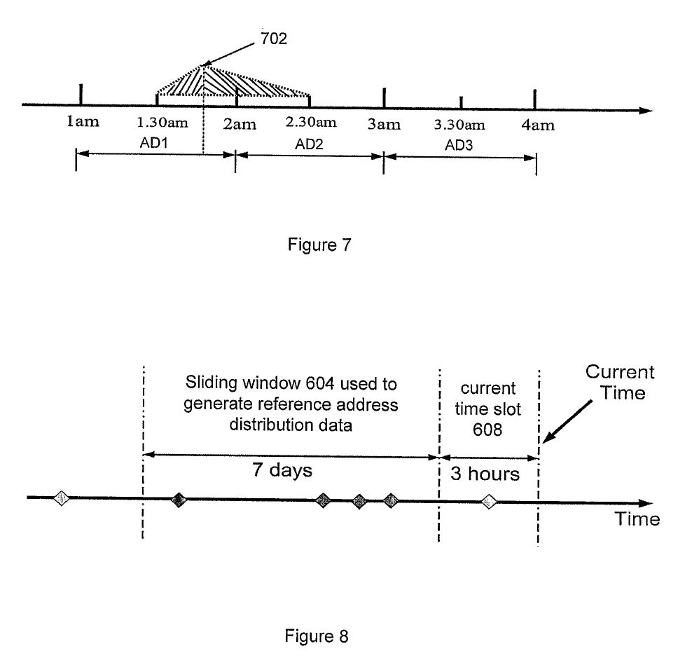

For example, FIG. 7 is a schematic representation of a time line from 1 am to 4 am on a particular day. The relevant reference address distribution data 312 for this time period consists of three populated data structures of the type 500 shown in FIG. 5, namely AD1 for the period beginning at 1 am and ending at 2 am, AD2 covering the period from 2 am to 3 am, and AD3 covering the period from 3 am to 4 am. The packet arriving at 1:45 am, represented as 702 in FIG. 7, could be simply compared with data structure AD1 covering the period from 1 am to 2 am, since the packet arrival time falls within this period. However, in order to provide a more accurate assessment, the statistical distance process uses a weighted average of distance values determined with respect to the two nearest reference address data structures, in this case AD1 and AD2. Each of these reference data structures is assumed to accurately represent the distribution at the midpoint of the time period covered by each distribution. That is, address distribution data AD1 is considered to accurately represent the statistical distribution of source addresses at 1:30 am, and AD2 is considered to accurately represent the situation at 2:30 am. Accordingly, the address distribution data for the current time slot 310 is used to generate a first distance value with respect to AD1, and a second distance value with respect to AD2, and these two distance values are then weighted proportionally by the difference in time between the midpoint of the current timeslot and each of the midpoint times of the two nearest profiles. Thus in this example the distance value with respect to AD1 would be weighted by 0.75, and the distance value with respect to AD2 would be weighted by 0.25.

Although the packet filtering system and process have been described above in terms of DoS attack detection and filtering, it will be apparent that the system and process can detect any anomalous or unusual changes in the distribution of source addresses, including those caused by other types of events, including flash crowd events. As described above, the filtering system will also select flash crowd source addresses for blocking, rate-limiting, or other processing. Although it is nevertheless generally desirable to block or rate-limit flash crowd visitors to a network site because it allows returning visitors to have normal access, it might be considered preferable in some cases to merely rate limit rather than block flash crowd visitors. In such cases arriving packets from the selected source address space can be processed further to assess whether they are more likely to be part of a flash crowd or a DoS attack. For example, characteristics of the source address space and the increase in network traffic can be used during a suspected attack to assess whether an attack or a flash crowd event is causing the changes in address distribution.

Many modifications will be apparent to those skilled in the art without departing from the scope of the present invention as hereinbefore described with reference to the accompanying drawings.

1. A process for detecting anomalous network traffic in a communications network, the process including:
generating reference address distribution data representing a statistical distribution of source addresses of packets received over a first time period, the received packets being considered to represent normal network traffic;
generating second address distribution data representing a statistical distribution of source addresses of packets received over a second time period; and
determining whether the packets received over the second time period represent normal network traffic on the basis of a comparison of the second address distribution data and the reference address distribution data.

2. The process of claim 1, wherein the statistical distributions of source addresses are statistical distributions of aggregated source addresses.

3. The process of claim 2, wherein the source addresses have structure and are aggregated on the basis of said structure.

4. The process of claim 1, wherein each of the statistical distributions of source addresses represents numbers of received packets or proportions of the total number of received packets having source address octets with corresponding values.

5. The process of any of claim 1, wherein each of the statistical distributions of source addresses represents numbers or proportions of received packets having portions of source addresses with corresponding values.

6. The process of claim 1, wherein the source addresses are aggregated on the basis of geographical locations associated with said source addresses.

7. The process of claim 1, wherein said step of determining includes generating distribution distance data representing a measure of similarity of the reference address distribution data and the second address distribution data, and determining whether the packets received over the second time period represent normal network traffic on the basis of the distribution distance data.

8. The process of claim 7, wherein said step of generating distribution distance data includes generating address subset distance data representing measures of similarity of respective portions of the reference address distribution data and corresponding portions of the second address distribution data, said portions corresponding to respective subsets of source addresses, said distribution distance data being generated from the address subset distance data.

9. The process of claim 8, wherein the step of generating the distribution distance data from the address subset distance data includes generating a weighted linear combination of the respective measures of similarity.

10. The process of claim 7, wherein said step of generating distance data includes determining a Mahalanobis distance between the two distributions.

11. The process of claim 7, wherein said step of determining includes processing respective distribution distance data generated for successive second time periods to generate filtered distribution distance data, said step of determining whether the packets received over the second time period represent normal network traffic being based on the filtered distribution distance data to improve the reliability of said determining.

12. The process of claim 11, wherein said step of processing includes generating a cumulative sum of the distribution distance data generated for successive second time periods.

13. The process of claim 1, wherein each of said reference address distribution data and said second address distribution data includes count data representing numbers of received packets having source addresses falling within respective source address subsets, and proportion data representing proportions of received packets having source addresses falling within said respective source address subsets.

14. The process of claim 1, wherein the process includes processing the reference address distribution data and the second address distribution data to generate updated reference address distribution data representing a statistical distribution of network addresses of packets received over an updated time period determined by extending the first time period to include the second time period, providing that said step of determining determines that the packets received over the second time period represent normal network traffic; wherein subsequently the updated reference address distribution data is used as the reference address distribution data and the updated time period is used as the first time period.

15. The process of claim 14, wherein the updated reference address distribution data is generated as a weighted linear combination of the reference address distribution data and the second address distribution data.

16. The process of claim 15, wherein the process includes selecting, in response to determining that the packets received over the second time period do not represent normal network traffic, at least one subset of the source addresses of packets received over the second time period, the subset of source addresses being selected on the basis of the comparison of the second address distribution data and the reference address distribution data.

17. The process of claim 16, including generating goodness values for respective selected source addresses, each of the goodness values representing a likelihood of packets having the corresponding source address representing abnormal network traffic.

18. The process of claim 17, wherein said goodness values are generated based on prior visiting behaviour associated with the selected source addresses.

19. The process of claim 18, including determining whether to block, rate-limit, or further process packets having each selected source address on the basis of said goodness value.

20. The process of claim 1, wherein the step of determining whether the packets received over the second time period represent normal network traffic includes determining whether the packets received over the second time period may represent a denial of service attack.

21. A computer-readable storage medium having stored thereon program instructions for executing the steps of claim 1.

22. A system having components for executing the steps of claim 1.

23. A system for detecting anomalous network traffic in a communications network, the system including:
a source address distribution generator for generating:
reference address distribution data representing a statistical distribution of source addresses of packets received over a first time period, the received packets being considered to represent normal network traffic; and
second address distribution data representing a statistical distribution of source addresses of packets received over a second time period; and
a network traffic assessment component for determining whether the packets received over the second time period represent normal network traffic on the basis of a comparison of the second address distribution data and the reference address distribution data.

24. The system of claim 23, wherein the source address distribution generator maintains address distribution data structures representing statistical distributions of source addresses of received packets, the address distribution data structures including a packet count data structure storing counts of received packets having source addresses falling within respective subsets of source addresses, and a packet proportion data structure storing proportions of the total number of received packets having source addresses falling within respective subsets of source addresses.

25. The system of claim 24, wherein the subsets of source addresses correspond to respective octets of said source addresses.
